(19) United States
(12) Patent Application Publication
(10) Pub. No.: US 2011/0295430 A1
(43) Pub. Date: Dec. 1, 2011

(54) Apparatus And Method For Managing Heating Or Cooling Of An Area In A Building

(76) Inventor: Andrey Kouninski, Alpharetta, GA (US)

(21) Appl. No.: 13/117,112

(22) Filed: May 26, 2011

Related U.S. Application Data
(60) Provisional application No. 61/348,568, filed on May 26, 2010.

(51) Int. Cl. G05D 23/19; G06F 1/32

(52) U.S. Cl. 700/278

(57) ABSTRACT

Apparatus for managing heating or cooling of an area in a building which includes a general processing unit adapted to communicate with the internet, a peripheral controller adapted to collect temperature data to control the heating or air conditioning of an area in a building, a central controller which communicates with the general processing unit and the peripheral controller. A motorized damper is controlled by the central controller, and a self auditing system is coupled to the central controller and the peripheral controller to audit remotely for trouble. A neural network engine is coupled to the general processing unit to generate commands to the peripheral controller and the central controller utilizes the temperature difference between the area of space in the building and outside the building to save energy and provide comfort.

### REFERENCE TO RELATED APPLICATIONS

This patent application claims the benefit of U.S. Provisional Application No. 61/348,568 filed on May 26, 2010, the disclosure of which is incorporated herein by reference in its entirety.

### BACKGROUND OF THE INVENTION

1. Field of the Invention

The present invention relates to apparatus and method for managing heating or cooling of an area of a building.

2. Description of Related Art

Apparatus and methods for managing the environment of a building is known in the prior art. More specifically, by way of example, U.S. PreGrant Publication No. 2003/0125843 to Prasad, P. V. K. generates the energy scheme for a facility based on geographic data, facility specific data, and an energy demand profile for the facility including at least a power component. The output energy scheme is generated in multiple options for a plurality of different demand situations, such as a situation that considers the energy needed to meet the facility's maximum and minimum energy demand.

U.S. PreGrant Publication No. 2003/0233201 to Horst; et al. discloses a controller in communication with energy consuming appliances which responds to requests for energy from energy consuming appliances by permitting or curtailing the energy supply to the appliances based on evaluation of a plurality of considerations.

U.S. PreGrant Publication No. 2004/0034484 to Solomita, J R.; et al. discloses a system that provides data to a computing platform detailing the energy usage of a consumer which allows the utility company to dynamically adjust rates and output levels so as to increase cost savings.

U.S. PreGrant Publication No. 2005/0171645 to Oswald; et al. uses measurements of the household electricity supply to identify and determine the energy consumption of individual household appliances. From these measurements, models are built of the behavior of the occupants of the house, the thermal properties of the house and the efficiency of the appliances. Using the models, the heating and cooling appliances are controlled to optimize energy efficiency.

U.S. PreGrant Publication No. 2010/0070101 to Benes; et al. discloses consumer defined triggers which provide consumers and utilities with the ability to control residential energy usage, by managing multiple residential load control elements. A user interface is provided separately from the load control elements to allow the consumer to define his or her schedule and preferences for the purposes of controlling the multiple load control elements.

U.S. Pat. No. 6,216,956 to Ehlers, et al. discloses a processor, coupled to compute an environmental condition range for multiple energy unit price points based on the user input parameters and controls at least one energy-consuming load device to maintain the indoor environmental condition for a current energy unit price point. The processor communicates with at least one energy supply company for a premise to minimize energy consumption cost.

U.S. Pat. No. 5,909,378 to De Milleville discloses a micro controller pre-set to operate heating, ventilation, air conditioning for maintaining the temperature in a room of a building at a desired ambient temperature. The system is capable of selectively operating the heating, ventilation, air conditioning devices and other energy consuming devices such as lighting, thermal storage heaters according to the occupancy of the room to provide a maximum saving of energy consumption.

U.S. Pat. No. 5,544,036 to Brown, Jr., et al. discloses one or more controllers in each facility being managed and one or more energy consuming devices attached to each controller. Each controller responds to digital paging signals from a central command center which establishes a schedule of events effecting the operation of each device and the controller schedules each device to be operated pursuant to the programmed schedule. The heating/cooling system is controlled by setpoint temperatures for each of a plurality of different modes of occupancy, whereby the most energy is consumed when the facility is occupied and lesser amounts of energy are consumed when the facility is empty.

U.S. Pat. No. 4,847,781 to Brown, III, et al. discloses a central unit which provides a series of energy managing signals over TV cables, power lines, telephone lines or free space radio frequency transmissions, to a plurality of subscriber units. Within each unit is a transponder which responds to the transmitted central unit signals and provides corresponding signals onto the power lines, within the subscribing unit. The appliances to be managed each have associated therewith a responder unit, which is coupled to the electric grid to receive the transponder provided signals.

### SUMMARY OF THE INVENTION

In an exemplary embodiment of the present invention there is disclosed apparatus for managing heating or cooling of an area in a building comprising: a general processing unit adapted to communicate with the internet;

a peripheral controller adapted to collect temperature data to control heating or air conditioning of an area in a building;

a central controller which communicates with the general processing unit and the peripheral controller;

a motorized damper controlled by the central controller;

a self auditing system coupled to the central controller and the peripheral controller to audit remotely for trouble; and

a neural network engine coupled to the general processing unit to generate commands to the peripheral controller;

wherein the central controller utilizes the temperature difference between the area in the building and outside the building to save energy and provide comfort.

In another exemplary embodiment of the present invention there is disclosed a method for managing heating or cooling of an area in a building, comprises:

providing a general processing unit adapted to communicate with the internet;

providing a peripheral controller adapted to collect temperature data to control heating or air conditioning of an area in a building;

connecting a central controller to communicate with the general processing unit and the peripheral controller;

providing a motorized damper which is controlled by the central controller;

coupling a self auditing system to the central controller and the peripheral controller to audit remotely for trouble; and

connecting a neural network engine to the general processing unit to generate commands to the peripheral controller;

wherein the central controller uses the temperature difference between the area in the building and outside the building to save energy and provide comfort.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a diagram for managing the heating/cooling of an area of a home, office or building in accordance with the principles of the invention.

### DESCRIPTION OF THE PREFERRED EMBODIMENT

The present invention generally provides apparatus and method for home and office resource management.

Current systems which are used for managing home and office heating and cooling systems normally consume a significant amount of energy on “stand-by mode” and are considered to be energy inefficient. Existing air duct clamps are normally open or normally closed. Existing system architectures are not normally flexible and/or expandable. They are partial and do not address all of the home or building needs nor do they provide buildings with self auditing features.

The system disclosed for managing home and/or office heating and cooling may include an open architecture and allow multiple devices to be connected and controlled through a central controller which will help resolve problems with efficient centralized resource management in a house, office or building.

An embodiment of the invention disclosed may reduce a system's own energy consumption with a motorized proportional low power consumption damper.

An embodiment of the invention may automatically turn on or off the heating, ventilation, and air conditioning (HVAC) and switch cooling/heating modes depending on programmed thresholds.

An embodiment of the invention may provide self-certification and auditing to a building.

In an embodiment of the invention the system may be audited remotely for trouble.

In an embodiment of the invention the system may send data and receive execution orders from a general processing unit (GPU) and cloud computing.

In an embodiment of the invention the system may provide an emergency mode when it is not capable of executing its functions for connecting an existing thermostat to the HVAC equipment.

In an embodiment of the invention the system may download execution code from a remote site, or may communicate with a PC, personal data assistant (PDA) or a phone which provides a controlling and informational interface.

In an embodiment of the invention the system may learn the living patterns of an occupant of a building and self adjust its behavior in collaboration with a neural network system to provide a plug and play connection to peripheral devices.

In an embodiment of the invention the system may be connected to the internet.

In an embodiment of the invention the system may collect information from detectors and pass this information to a central controller which may turn an HVAC and cooling/heating modes on or off, and open or close air vent clamps to provide energy flow to required areas. In an advanced mode, all information may be passed to a GPU.

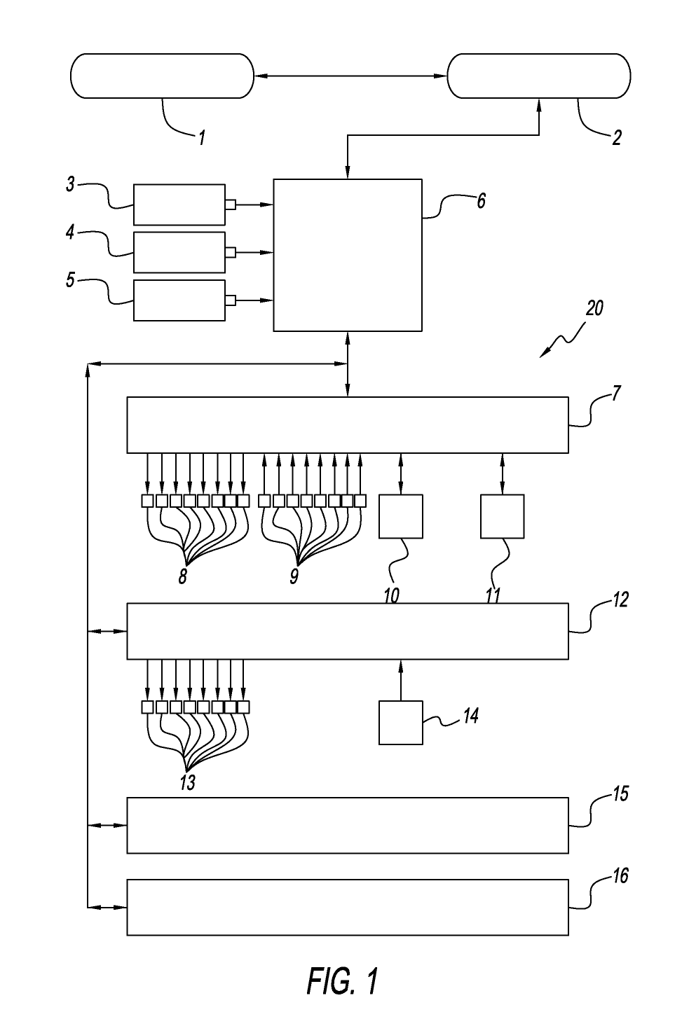

Referring to FIG. 1, there is shown a system 20 for managing the heating/cooling of a home, office or building in accordance with the principles of the invention. As shown in FIG. 1, the system may include a general processing unit (GPU) 1, where the processing unit may include a neural network engine to employ neural network algorithms. The general processing unit communicates with the internet via cloud computing 2, which may provide a central controller with connection to the outside world, advanced services and/or remote troubleshooting. The system may include an AC power supply 3 which may provide power for functioning, a renewable power supply 4, which may provide additional power from a renewable source, and may include a battery backup 5, which may provide additional back up power for operation. Each of the power supplies is connected to a central controller unit 6 which is provided to perform and control an algorithm execution, and may communicate with the neural network engine 1 and with the cloud computing 2.

Central controller 6 may be connected to provide a web user interface, may communicate utilizing a keyboard, and may utilize plug-in software modules. The system may include a peripheral controller 7, which may be connected to control air duct clamps 8, collect temperatures from temperature detectors 9 or other information from the area, and communicate with the central controller 6. The air duct clamps 8 may include motorized clamps with zero power consumption when in a “stand by” mode and HVAC equipment 10. In an embodiment where the invention is installed in an existing building where an original thermostat 11 may already be installed, the original thermostat 11 may take over HVAC control in case of a malfunction of the system. The system may include an irrigation module 12 which may communicate with central controller 6 to control water irrigation valves. Irrigation module 12 may collect information from a rain detector 14 which provides information about the amount of rain that has fallen, and the irrigation valves 13 may be electromechanical valves. The system may include a keypad with liquid crystal display (LCD) 15. The system may be located at any convenient place in the home, office of building and may include a peripheral controller 16 with general and specific applications. Controller 16 may support future implementations and system expansion, where the function can vary depending on customer requirements.

An embodiment of the invention may include a central controller, AC power supply or renewable power supply, and at least one peripheral controller.

In an embodiment of the invention, a GPU may be connected to the internet and to the central controller. Other elements may be connected through one or more local interfaces, such as an RS485 or Zigbee.

In an embodiment of the invention the peripheral controller may collect information from temperature detectors located in the area of space in a building and from an outside temperature detector and pass this information to the central controller. The central controller may make a decision based on the collected information and send a command signal to the HVAC equipment through peripheral controllers for cooling or heating the area of space in the building. The central controller may utilize the temperature difference between the area of space in the building and the outside to save energy and provide comfort to an occupant in the area of space in the building. At the same time, based upon threshold settings for each area, clamps may be turned on or off to provide energy flow to required areas of space.

In an embodiment of the invention having an advanced mode, collected information may be processed using cloud computing and neural networks on the GPU to generate commands which are sent to the peripheral devices. A user may utilize the system through a WEB user interface (UI) or through keypad programming to set low and high thresholds for every controlled area.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. Apparatus for managing heating or cooling of an area in a building, comprising:
a general processing unit adapted to communicate with the internet;
a peripheral controller adapted to collect temperature data to control heating or air conditioning of an area in a building;
a central controller which communicates with the general processing unit and the peripheral controller;
a motorized damper controlled by the central controller;
a self auditing system coupled to the central controller and the peripheral controller to audit remotely for trouble; and
a neural network engine coupled to the general processing unit to generate commands to the peripheral controller;
wherein the central controller utilizes the temperature difference between the area in the building and outside the building to save energy and provide comfort.

2. The apparatus of claim 1 wherein the general processing unit includes cloud computing to generate commands to the peripheral controller.

3. The apparatus of claim 2 wherein the damper is a low power consumption damper.

4. The apparatus of claim 3 wherein the damper uses no power when in its stand by mode.

5. The apparatus of claim 2 wherein the central controller is coupled to receive power from an AC power supply.

6. The apparatus of claim 5 wherein the central controller is coupled to receive back up power from a battery.

7. The apparatus of claim 6 wherein an irrigation module which is coupled to control water valves is coupled to the central controller.

8. The apparatus of claim 7 wherein a rain detector for providing information about rain presence is coupled to the irrigation module.

9. The apparatus of claim 8 wherein a keypad with a liquid crystal display is coupled to the central controller and the irrigation module.

10. A method for managing heating or cooling of an area in a building, comprises:
providing a general processing unit adapted to communicate with the internet;
providing a peripheral controller adapted to collect temperature data to control heating or air conditioning of an area in a building;
connecting a central controller to communicate with the general processing unit and the peripheral controller;
providing a motorized damper which is controlled by the central controller;
coupling a self auditing system to the central controller and the peripheral controller to audit remotely for trouble; and
connecting a neural network engine to the general processing unit to generate commands to the peripheral controller;
wherein the central controller uses the temperature difference between the area in the building and outside the building to save energy and provide comfort.

11. The method of claim 10 wherein the general processing unit includes cloud computing to generate commands to the peripheral controller.

12. The method of claim 11 wherein the damper is a low power consumption damper.

13. The method of claim 12 wherein the damper uses no power when in its stand by mode.

14. The method of claim 11 wherein the central controller is coupled to receive power from an AC power supply.

15. The method of claim 14 wherein the central controller is coupled to receive back up power from a battery.

16. The apparatus of claim 15 wherein an irrigation module which is coupled to control water valves is coupled to the central controller.

17. The apparatus of claim 16 wherein a rain detector for providing information about rain presence is coupled to the irrigation module.

18. The apparatus of claim 17 wherein a keypad with a liquid crystal display is coupled to the central controller and the irrigation module.
